(19) United States
(12) Patent Application Publication
(10) Pub. No.: US 2008/0043277 A1
(43) Pub. Date: Feb. 21, 2008

(54) Printing system and method

(75) Inventors: Tomas Bystrom, London (GB); Thomas E. Chase, Welwyn Garden City (GB); Andrew Jordan, Herts (GB)

Correspondence Address: FAY SHARPE / XEROX - ROCHESTER, 1100 SUPERIOR AVE., SUITE 700, CLEVELAND, OH, 44114, US

(73) Assignee: Xerox Corporation, Stamford, CT (US)

(21) Appl. No.: 11/506,736

(22) Filed: Aug. 18, 2006

(51) Int. Cl. G06F 3/12

(52) U.S. Cl. 358/1.15; 358/1.1

(57) ABSTRACT

A printing system capable of automatically outputting a printed representation of associated XML content data retrieved from an associated XML content source includes a sheet media source, a marking unit and a sheet media outlet. A control system is in communication with at least the marking unit and is capable of automatically retrieving associated XML content data from the associated XML content source. The control system is also capable of automatically interpreting associated information data from the associated XML content data, and automatically generating associated marking data based at least in part on the associated information data and communicating the associated marking data to the marking unit.

### BACKGROUND

The present disclosure broadly relates to the art of printing systems and, more particularly, to a printing system for and method of automatically generating a printed representation of associated XML content from an associated XML content source.

The terms “print”, “printing” and “marking” as used herein are to be broadly interpreted to encompass any action or process involving the production or output of sheet media having text, images, graphics and/or other indicia formed thereon by any process, such as inkjet or electrophotographic processes, for example. The terms “printer” and “printing system” as used here are to be broadly interpreted to encompass any device, apparatus or system that is capable of performing a “printing” action. Examples of such equipment and/or systems include, without limitation, desktop printers, network printers, stand-alone copiers, multi-function printer/copier/facsimile devices, and high-speed printing/publishing systems. Additionally, such exemplary embodiments of equipment, systems and/or processes can utilize sheet media of any suitable type, kind, material, quality or thickness (e.g., recycled paper, plain paper, bond paper, coated paper, card stock, transparencies and/or other media), for example. Furthermore, such exemplary equipment, systems and/or processes can output indicia on such sheet media using any printing or marking substance, such as liquid ink, solid ink, toner and/or colorant, for example, in monochrome (e.g., black) or one or more colors, or any combination thereof.

Additionally, the subject matter of the present disclosure is particularly well suited for use on and in association with multiple-function printing systems and will be discussed herein with particular reference thereto. However, the subject matter of the present disclosure is capable of broad use in a wide variety of applications and environments. As such, it is to be distinctly understood that the showings and discussion herein are merely exemplary and are not intended to be limiting.

It is generally well known to publish, deliver and/or otherwise distribute content, such as data and information, in any one or more of various forms (e.g., text, images, sound and/or video) over private and public communication networks, such as intranets and internets (including the Internet). As content is increasingly distributed over such communication networks, new applications for presenting the content continue to be developed. One well established example of such an application is widely known as the World Wide Web.

It is a common practice for users to access content presented on the World Wide Web and send the content to a suitable printing system to obtain a printed representation thereof. One characteristic of the World Wide Web, however, is that the content is transferred to users in a largely graphical form, which is displayed in a manner that is primarily controlled by the content provider. That is, the data and information for formatting and displaying the content is integrated with the informational content that is being accessed by the user. As such, users that receive content presented on the World Wide Web normally have little control over how the content is displayed on a computer screen.

One disadvantage of simply printing a hard copy of the content is that the user will first have to access the content before a printed representation thereof can be generated. For a small amount of content, such as one or only a few content sources, the task of accessing and generating a hard copy of the content can be performed relatively easily by the user and in a relatively short period of time. However, as the number of content sources that the user desires to access increases, the time and effort involved can become much more significant.

Another disadvantage of simply printing a hard copy of the content as it is displayed to the user on a computer screen is that the display formatting is often incorrectly sized for output on sheet media. For example, content, such as a news article, for example, may be formatted for display in a small area of a computer screen such that the entire article cannot be displayed at one time. In which case, each successive section of the article would have to be printed on a separate sheet of media to generate a hard copy of the entire article. While the content provider may provide a secondary format for printing, the is left to the discretion of the content provider. Additionally, this often undesirably requires that the user take further steps or actions to access the content that is formatted for hard copy output, the disadvantages of which have been discussed above.

A further disadvantage of the traditional practice of manually accessing and reviewing content sources, such as on the World Wide Web, for example, and generating hard copy representations of content thereon is that many content sources are infrequently updated. What's more, such content sources are normally poorly suited and/or incapable of notifying a user when new or updated content has been provided. As such, a user may access a content source each day or week in search of new data and/or information only to find that the content is unchanged.

### BRIEF DESCRIPTION

A printing system capable of automatically outputting a printed representation of associated XML content data retrieved from an associated XML content source is provided that includes a sheet media source adapted to receive and dispense a quantity of associated sheets of media. A marking unit is operatively connected to the sheet media source. The marking unit is adapted to receive the associated sheets of media from the sheet media source and to generate associated marked sheets of media having a printed representation thereon. A sheet media outlet is in operative communication with the marking unit and receives the associated marked sheets of media. A control system is in communication with at least the marking unit and is capable of automatically retrieving associated XML content data from the associated XML content source, automatically interpreting associated information data from the associated XML content data, and automatically generating associated marking data based at least in part on the associated information data and communicating the associated marking data to the marking unit.

A printing system capable of automatically outputting a printed representation of associated XML content data retrieved from an associated XML content source is provided that includes a sheet media source adapted to dispense associated sheets of media. A marking unit is operatively connected to the sheet media source. The marking unit is adapted to receive the associated sheets of media from the sheet media source and to generate associated marked sheets of media having a printed representation thereon. A sheet media outlet is in operative communication with the marking unit and receives the associated marked sheets of media. A control system is in communication with at least the marking unit and includes a communication interface operative to communicate with the associated XML content source, and a retriever operative to retrieve the associated XML content data from the associate XML content source through the communication interface. The control system also includes an interpreter operative to parse the associated XML content data from the retriever into at least associated information data. The control system further includes a generator that is operative to generate associated marking data based at least in part on the associated information data from the interpreter and to communicate the associated marking data to the marking unit for generation of the associated marked sheets of media.

A method of automatically generating a printed representation of XML content data from an XML content source is provided that includes providing a printing system capable of communicating with the XML content source. The method also includes configuring the printing system to retrieve XML content data from an XML content source. The method further includes retrieving XML content data from the XML content source using the printing system. The method also includes parsing information data from the XML content data using the printing system, and generating a printed representation of the information data using the printing system.

### BRIEF DESCRIPTION OF THE DRAWINGS

FIG. 1 is a schematic representation of one embodiment of a printing system capable of automatically generating a printed representation of associated XML content from an associated XML content source.

FIG. 2 is a flowchart of one exemplary method of automatically generating a printed representation of associated XML content from an associated XML content source.

FIGS. 3-5 are representations of exemplary user interface screens for configuring a printing system to access associated XML content from an associated XML content source.

FIG. 6 is a flowchart of one exemplary method of configuring a printing system to access associated XML content from an associated XML content source.

### DETAILED DESCRIPTION

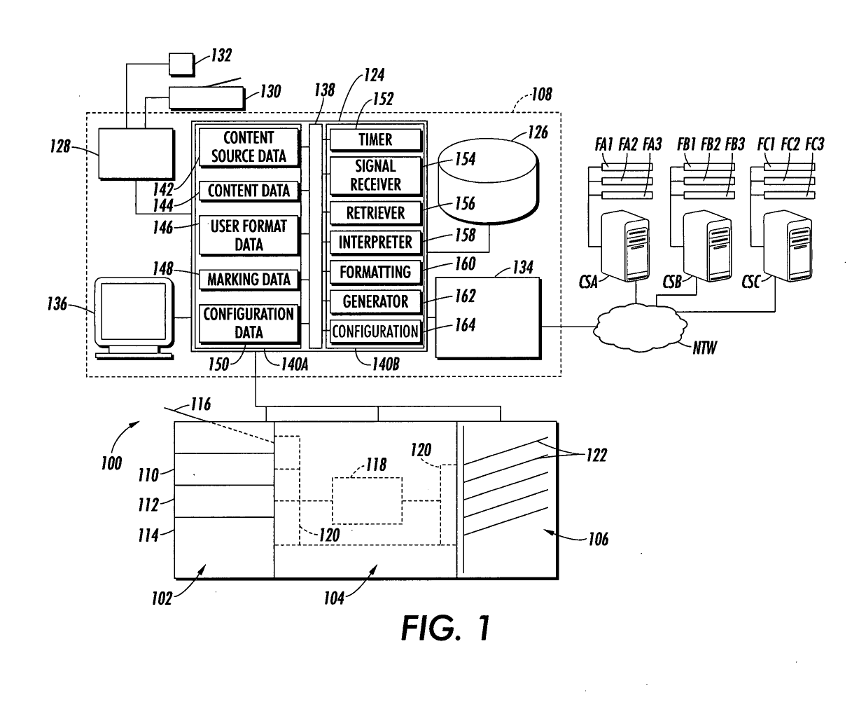

Turning now to the drawings wherein the showings are for the purpose of illustrating exemplary embodiments, and not for limiting the same, FIG. 1 schematically illustrates a printing system 100 that includes a sheet media source 102, a marking system 104 in operative communication with the sheet media source, and a sheet media outlet 106 in operative communication with the marking system. Printing system 100 also includes a control system 108 in communication with one or more of the sheet media source, the marking system and/or the sheet media outlet for selective operation thereof. In the embodiment shown in FIG. 1, control system 108 is in communication with each of these systems. It is to be distinctly understood, however, that aspects of the present disclosure are applicable to a wide variety of types and kinds of printing systems, and that printing system 100 is merely exemplary of one suitable printing system.

Media source 102 is shown in FIG. 1 as including multiple media supply trays 110, 112 and 114 suitable for storing bulk quantities of sheet media. Media source 102 also includes a bypass supply tray 116 capable of handling smaller quantities of sheet media. It will be appreciated that the supply trays are operative to introduce individual sheets of media to a suitable sheet feeding system or mechanism for dispensing the individual sheets. Additionally, it will be appreciated that media supply trays 110-116 are capable of receiving and supporting quantities of sheet media of any one of a variety of different sizes (e.g., letter, legal, A4) and/or orientations (e.g., short-edge first, long-edge first).

Marking system 104 includes one or more printing engines 118 in communication with media source 102 through a media transport pathway 120. It will be appreciated that the one or more printing engines can be of any suitable type or kind, and that such one or more printing engines will operate in accordance with known marking principles, such as ink jet marking or electrophotographic marking, for example.

Sheet media outlet 106 includes one or more output trays 122, and is in communication with the one or more printing engines of marking system 104 via media pathway 120. The sheet media outlet can be of any suitable type or kind, and can optionally be capable of performing one or more finishing operations of any type or kind. For example, sheet media outlet 106 could be operative to stack, collate, staple, hole punch, offset, bind, fold, insert separator sheets, and/or any combination of these or any other finishing operations.

As will be recognized by one of skill in the art, sheet media is fed from media source 102 to the one or more printing engines 118 along media pathway 120. Once output by the printing engine or engines, the marked sheet media is delivered to the sheet media outlet and can simply be stacked, or one or more optional finishing operations can be performed.

In the exemplary embodiment shown in FIG. 1, control system 108 includes a controller 124 in communication with media source 102, marking system 104 and sheet media output 106, each in a suitable manner. Control system 108 can also optionally include a data storage device 126, such as a non-volatile memory or hard disk drive, for example, suitable for data and/or information, such as printing system data, print job data (e.g., print job settings and attributes), user-related information (e.g., user preferences), content source data (e.g., universal resource location data) and any other data and/or information. The data storage device is shown in FIG. 1 as being in direct communication with controller 124, though it will be appreciated that any other suitable arrangement could alternately be used.

Additionally, control system 108 can optionally include an input interface 128, which is shown in FIG. 1 as being in communication with controller 124. Input interface 128 can be used to generate, receive, input or otherwise provide print jobs to the printing system. For example, input interface 128 can be in communication with an optional raster output scanning system 130 and/or an optional memory device reader 132. Control system 108 also includes a communication interface 134 capable of communicating with one or more content sources, such as one or more of content servers CSA, CSB and CSC, for example, which are shown in FIG. 1. It will be appreciated that communication interface 134 can be of any suitable type, kind and/or configuration and can be capable of communicating with the one or more content sources in any suitable manner, such as through any suitable private or public communication network, for example. As shown in FIG. 1, the communication interface is in communication with the content servers through a communication network NTW, which represents a suitable private or public communication network, such as an intranet or an internet (including the Internet). It will be further appreciated that data and/or information received through communication interface 134 can be directly communicated to controller 124 for processing as a print job, or the data and/or information can be stored in a suitable manner, such as within data storage device 126, for example, until recalled for processing and/or printing.

Turning, briefly, to the topic of content sources, it will be appreciated that the same can be of any suitable type, kind and/or configuration. In the exemplary arrangement shown in FIG. 1, the content sources are content or computer servers CSA, CSB and CSC that store or otherwise include content in the form of one or more computer files, which are respectively represented in FIG. 1 as computer files FA1-FA3, FB1-FB3 and FC1-FC3. The content can be represented in the computer files in any suitable manner that permits parsing or separating of the informational content data from the formatting and/or display data. One example of a computer programming language that has come into use on the World Wide Web and that utilizes a format in which the informational content is separable from the data and information used for formatting and display purposes is commonly referred to as “extensible markup language” or XML.

Various applications that are based on or otherwise utilize XML have been or are currently being developed. One example of such an application is commonly referred to as RSS, which can stand for Rich Site Summary, RFD Site Summary or Really Simple Syndication, depending on the version thereof that is being used. One feature of RSS is that computer files, such as files FA1-FA3, FB1-FB3 and/or FC1-FC3, for example, can be generated in a manner in which the informational content data and formatting and/or display data are separate or separable. Additionally, other data tags and/or markers can be incorporated into the data and/or information within the computer files, and such data tags or markers can be used to provide additional information regarding the disseminated content, such as date and/or time data, for example. Another feature of RSS and applications associated therewith is that the same permit new, updated or otherwise revised content to be automatically “pushed” out to users. Presently, this can be accomplish in any one of several different systems, methods and/or ways. Regardless of the application that is employed, users can be automatically notified when the content of a given content source has been updated or revised. As a result, the user does not have to repeatedly access the content source manually to check for new or updated content.

Returning, now, to printing system 100 in FIG. 1, a user interface, such as a display, keyboard, pointing device, associated computing device (e.g., a remotely connected or networked computer) or other input device, is in communication with controller 124. In one preferred embodiment, a display 136 is provided that outputs a graphical programming window to the user for communication of text, data and/or information to a user. Additionally, the user interface is adapted for user input of text, data and/or information, such as from the keyboard (not shown), pointing device (not shown) or touch-screen input on display 136, for example. It will be appreciated, however, that such data can be inputted in any suitable manner.

Control system 108 can also include any suitable hardware, software and/or combination thereof for configuration and operation of the printing system. For example, control system 108 can include a processing device, which can be of any suitable type, kind and/or configuration, such as a microprocessor, for example, for processing data, executing software routines/programs, and other functions relating to the performance and/or operation of printing system 100. Additionally, the control system can include a memory of any suitable type, kind and/or configuration that can be used to store software, parameters, settings, inputs, data, values and/or other information for use in association with the performance and/or operation of the printing system. In the embodiment shown, controller 124 includes a microprocessor 138 and a memory 140, which is represented in FIG. 1 by boxes 140A and 140B. It will be appreciated, however, that the control system, including any controller, processing device and/or memory, can take any suitable form, configuration and/or arrangement.

Memory 140 can store or otherwise retain any suitable data, values, settings, software, algorithms, routines, programs and/or any other information, in any suitable manner or form. For example, memory 140A can store or otherwise include content source data 142, such as data, values and/or information related to universal resource locations (URLs) of one or more content servers, for example. Additionally, memory 140A can optionally store or otherwise include content data 144, such as data, values and/or information related to retrieved content from one or more content sources, for example. Such data, values and/or information can include raw content data retrieved from a content source and/or informational content data that has been parsed or otherwise extracted from such raw content data. Furthermore, memory 140A can store or otherwise include user format data, values and/or information 146, such as may be related to user preferences for formatting and outputting printed representations of retrieved content, for example. Memory 140A can also be capable of storing or otherwise including marking data 148, such as may be suitable for communication to a marking system, such as marking system 118, for example, for generation of a printed representation of retrieved content. Additionally, memory 140A can store or otherwise include system configuration data, values and/or information 150, such as may be related to the settings, capabilities and/or operation of the printing system.

Memory 140B can optionally store or otherwise include an algorithm, routine or program 152 for determining a suitable interval for contacting a content source, such as to potentially retrieve new and/or updated data, for example, and for generating a corresponding signal or other communication having a relation to the interval determination. Memory 140B can also optionally store or otherwise include a signal receiving algorithm, routine or program 154 for receiving a communication signal, such as for indicating that new or updated content is available from a given content source, for example. Such a communication signal could be received from a content server or another system, service, or device, for example. Memory 140B can also store or otherwise include a retriever algorithm, routine or program 156 for retrieving content data, such as data 144, for example, from one or more content sources. Memory 140B also stores or otherwise includes an algorithm, routine or program 158 for parsing, extracting or otherwise interpreting informational content from content data, such as data 144, for example.

Memory 140B can optionally store or otherwise include an algorithm, routine or program 160 for formatting information content data for output based on user preferences, such as may be retained as user format data 146, for example. Memory 140B also stores or otherwise includes an algorithm, routine or program 162 for generating marking data, such as marking data 148, for example. If a formatting routine, such as may be retained in memory store 160, for example, is used, the marking data generated by routine 162 can be based on the formatted content data that may be output by the formatting routine. Otherwise, the marking data generated by routine 162 can be based on informational content data and optionally user format data, such as content data 144 and user format data 146, for example. Memory 140B can further store or otherwise include an algorithm, routine or program 164 for configuring the printing system, such as for the user entry of printer settings (e.g., configuration data 150), user preferences (e.g., user format data 146), and/or content source location information (e.g., content source data 142), for example.

It will be appreciated that the configuration and operation modules of control system 108, which are presented in this exemplary embodiment as algorithms, routines and/or programs 152-164, can be provided in any suitable manner, such as software, hardware and/or a combination of hardware and software, for example, and are not intended to be limited to the arrangement described above, which is merely exemplary. If provided in whole or in part as software, the configuration and operation modules of control system 108 can be provided and stored in any suitable manner or arrangement. For example, all of the algorithms, routines and/or programs could be integrated into a single software program in which separate sections or portions of the software code will perform the various actions and/or activities of the control system. In another embodiment, two or more independent modules (e.g., algorithms, routines and/or programs) could be used to perform the various actions and/or activities of the control system.

Microprocessor 138 is in communication with memory 140 and is operative to selectively access and/or process one or more of data, information, algorithms, routines and/or programs retained in memory stores 142-164, alone or in combination. For example, microprocessor 138 could receive data, signals or other suitable indications from an associated device or system, or from an algorithm, routine or program the microprocessor is running, such as from one of memory stores 152 or 154, for example, indicating that new or updated content may be available from a given content source, such as from one of the content servers, for example. Microprocessor 138 could then access memory store 142 to retrieve content source data (e.g., URL data) and memory store 156 to retrieve the routine for retrieving new or updated content data from the given content source. Upon retrieving the new or updated content data, the same or a portion thereof could be stored in memory store 144 for later processing. Alternately, microprocessor 138 could access memory store 158 to retrieve the routine for interpreting content data, and process the new or updated content data to parse or otherwise extract the information content therefrom.

Once the informational content is parsed or otherwise extracted, the information content data could be stored by the microprocessor in memory store 144. As one option, microprocessor 138 could access memory store 160 to retrieve a routine for formatting the content data and access memory store 146 to retrieve the user format data. The microprocessor could then generate formatted content data based thereon. In such case, microprocessor could then access memory store 162 to retrieve the routine for generating marking data. The microprocessor could then generate the marking data from the formatted content data. Alternately, the microprocessor could optionally access memory store 146 to retrieve user format data, and then generate marking data corresponding to the parsed or extracted informational content and optionally to the user format data, rather than utilizing formatting routine 160. In either case, microprocessor 138 can then output the marking data to marking system 104 for generation of a printed representation of the informational content. Additionally, the microprocessor could access memory store 148 to retrieve previously stored marking data or, alternately, the microprocessor could forward the generated marking data to memory store 148 later usage. It will be appreciated, however, that the foregoing illustrations are merely exemplary and that any other suitable processes and/or operations could alternately be performed.

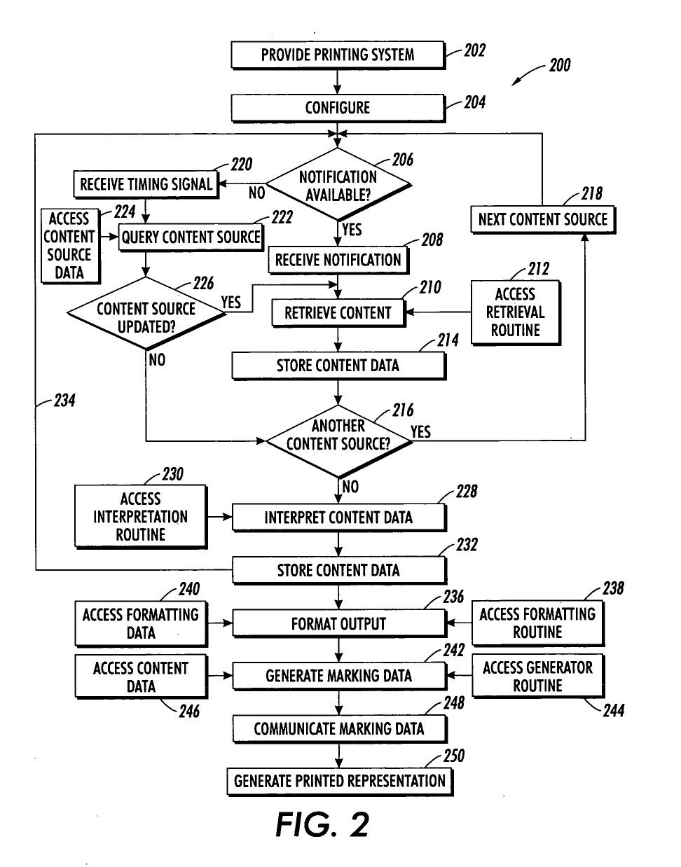

One example of a method 200 of automatically outputting a printed representation of XML content data from an XML content source is shown in FIG. 2. Method 200 includes providing a printing system, such as printing system 100, for example, as indicated by box 202. Method 200 also includes configuring the printing system, as indicated by box 204. Configuring the printing system can include, without limitation, inputting location-related information regarding content sources, inputting user preference information regarding performance and outputting of printed representations, and/or inputting printing system settings and/or parameters, for example.

It will be appreciated that different XML applications will include different features and capabilities, such as whether or not content can be “pushed” out to users, for example. As such, an inquiry is made at decision box 206 as to whether notification of new or updated content is available. If a YES determination is made, method 200 proceeds to box 208 at which a notification, such as receipt of a data signal, for example, is received, which indicates that a given content source has new or updated content available. Normally, the notification signal will include sufficient content source data or information for locating or otherwise communicating with the content source to retrieve the new or updated content. Having receive a notification signal, method 200 proceeds box 210 at which the new or updated content is retrieved from the content source. Prior to retrieving the new or updated content, a retrieval routine, such as may be retained in memory store 156, for example, can be accessed, as indicated by box 212. Method 200 can then optionally store the raw content data, such as in memory store 144, for example, as indicated by box 214. Method 200 then reaches a decision box 216 at which an inquiry is made as to whether content from another content source could be retrieved. If a YES determination is made at decision box 216, method 200 can index to another content source, as indicated by box 218, and return for a further inquiry at decision box 206.

Alternately, if a NO determination is made at the earlier inquiry at decision box 206, a timing signal can be received and used to determine when to check for new or updated content, as indicated by box 220. It will be appreciated that the timing signal can be generated in any suitable manner, such as by using the program in memory store 152, for example. Once the timing signal is received, method 200 proceeds to query a content source for new or updated information, as indicated in box 222. Prior to querying the content source, content source data, such as may be retained in memory store 142, for example, can be accessed, as indicated by box 224. Method 200 can then proceed to a decision box 226 at which an inquiry is made as to whether the queried content source has been updated with new and/or revised content. If a NO determination is made, method 200 proceeds to decision box 216 to determine whether content from another content source could be retrieved. If a YES determination is made, method 200 proceeds to retrieve the new or updated content from the content source, as discussed with regard to by box 210.

Once a desired amount of content has been received, a NO determination is returned at decision box 216 and method 200 can proceed to interpret the content, as indicated by box 228, and parse or otherwise extract the informational content therefrom. Prior to interpreting the informational content data, an interpreting routine, such as may be retained in memory store 158, for example, can be accessed, as indicated by box 230. Optionally, method 200 can store the interpreted content data, as indicated by box 232. In which case, method 200 can optionally return to retrieving content data, as indicated by line 234. If the content data is not stored at box 232, method 200 can optionally proceed to format the interpreted content data for output, as indicated by box 236, such as in accordance with user preferences, for example. However, prior to formatting the interpreted content data, a formatting routine, such as may be retained in memory store 160, for example, and user format data, such a may be retained in memory store 146, for example, can be accessed, as indicated by boxes 238 and 240, respectively. Method 200 can then generate marking data based on the formatted content data. Alternately, method 200 can generate marking data directly corresponding to the informational content, as indicated by box 242. Prior to generating the marking data, a generator routine, such as may be retained in memory store 162, for example, and stored content data, such as may be retained in memory store 144, for example, can be accessed, as indicated by boxes 244 and 246, respectively. In either case, method 200 includes communicating the marking data, however generated, to a printing system, as indicated by box 248. Method 200 can then proceed to generated a printed representation of the informational content, as indicated by box 250.

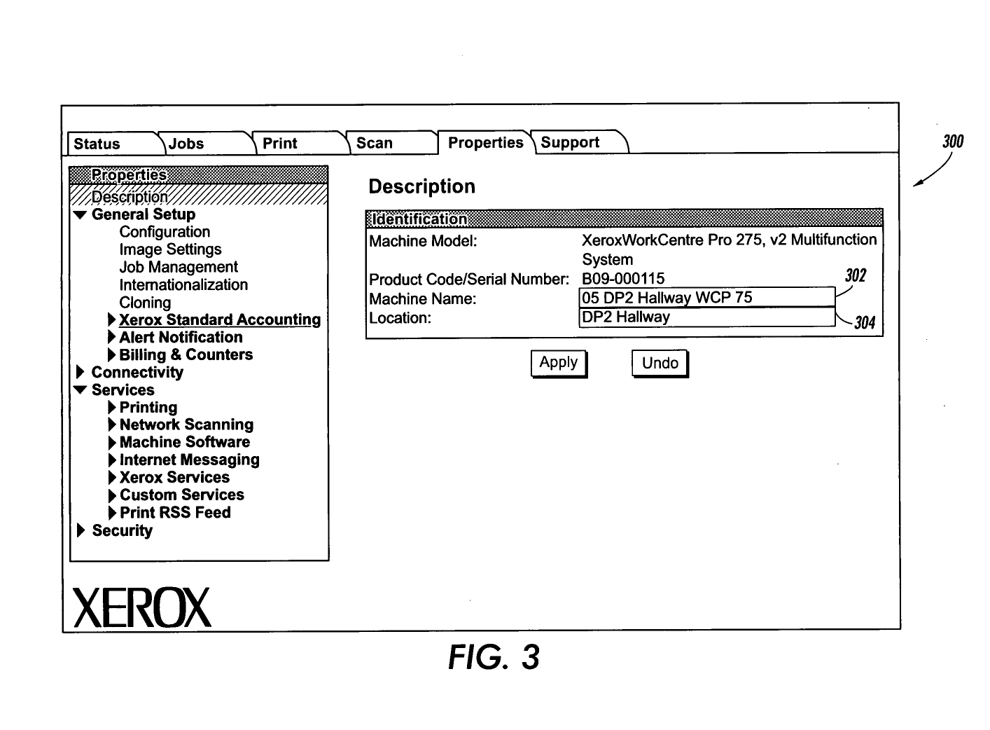

Printing systems, such as printing system 100, for example, can be configured in any suitable manner for automatically generating a printed representation of XML content retrieved from an XML content source. For example, an algorithm, routine or program, such as could be retained in memory store 162, for example, could be operable as a user interface for entry of data, values and/or information, such as could be retained in memory store 150, for example, for configuring a printing system. FIGS. 3-5 represent examples of graphical user interface screens or programming windows that could be used for user entry of such data, values and/or information. However, it will be understood that any other suitable arrangement could alternately be used. Additionally, it will be appreciated that such graphical user interface programming windows can be displayed on a suitable display or monitor, such as display 136 or a remote computer terminal (not shown), for example. Furthermore, it will be appreciated that selection and movement through and/or between the foregoing and other graphical user interface screens can be performed in any suitable manner, such as by using a graphical selection device and an HTML programming interface, for example.

FIG. 3 represents an example of a graphical user interface screen 300 suitable for the entry of general information regarding a printing system. For example, screen 300 is shown as including a text entry field 302 suitable for entry of data, values and/or information descriptive of user-friendly name for the printing system. Screen 300 also includes a text entry field 304 suitable for entry of data, values and/or information relating to the physical location of the printing system. It will be appreciated that screen 300 is merely exemplary of one suitable graphical user interface screen and that any other arrangement could alternately be used. Also, it will be appreciated that provisions for the entry of any other suitable data, values and/or information could additionally, or alternately, be provided on screen 300. For example, information relating to the identity of the user, a department or location to receive the output, and/or a title of the service could similarly be entered.

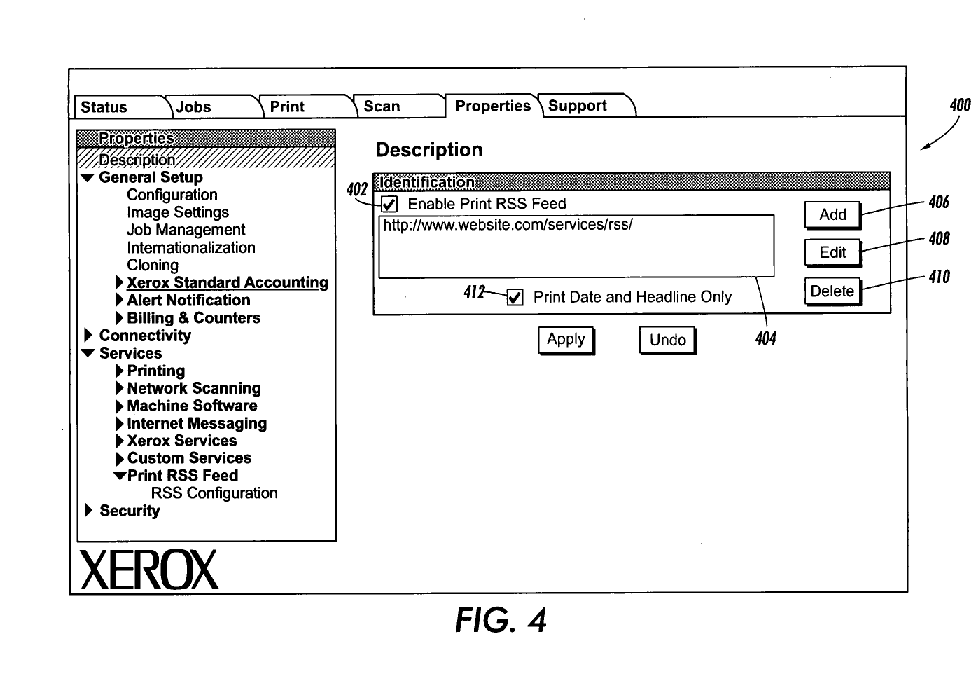

FIG. 4 represents an example of a graphical user interface screen 400 suitable for displaying content sources along with data, values and/or information related thereto. Additionally, screen 400 can be used for the entry and/or display of user preferences and/or settings for the one or more content sources. For example, screen 400 includes a check box 402 for initializing the automatic retrieval and printing of XML content from one or more XML content sources. Screen 400 is also shown as including a box 404 operative to list the one or more XML content sources from which the user desires to have content automatically retrieved and printed. Additionally, buttons 406, 408 and 410 are provided for respectively adding, editing and deleting content sources listed in box 404. Furthermore, a check box 412 is provided for permitting the user to select between retrieving and printing the full informational content or a lesser portion thereof, such as date and headline of the content, for example. It will be appreciated that screen 400 is merely exemplary of one suitable graphical user interface screen and that any other arrangement could alternately be used. Also, it will be appreciated that provisions for the entry of any other suitable data, values and/or information could additionally, or alternately, be provided on screen 400.

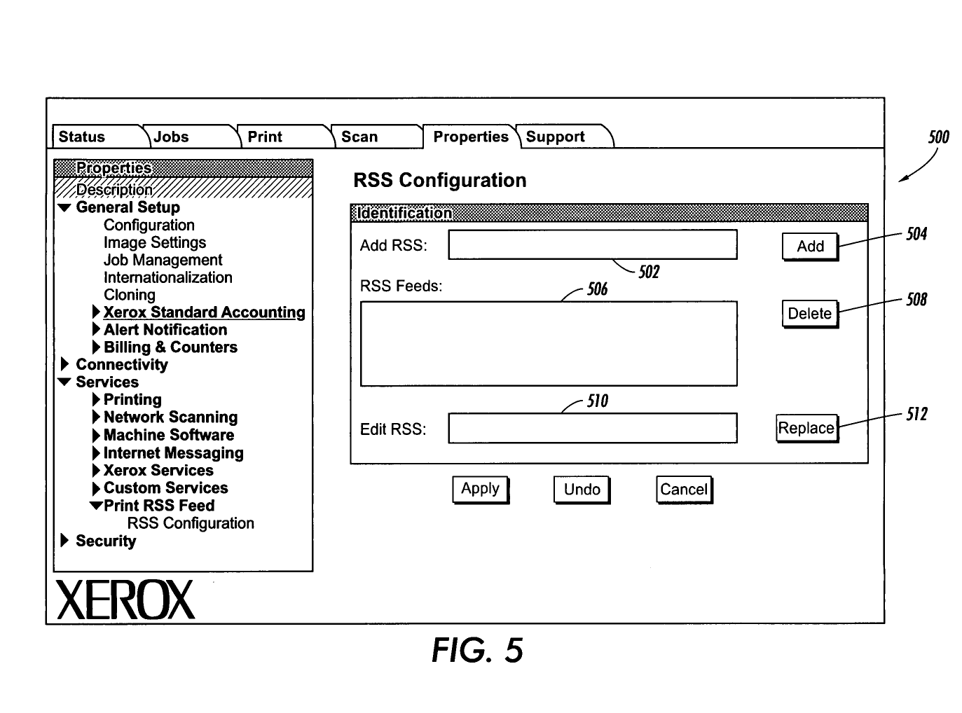

FIG. 5 represents an example of a graphical user interface screen 500 suitable for adding, editing and/or deleting content sources and/or data, values and/or information related thereto. For example, screen 500 includes a text entry field 502 suitable for entry of data, values and/or information relating to a new or additional content source, and an associated button 504 for adding content sources entered in field 502. Screen 500 is also shown as including a box 506, which is similar to box 404 in FIG. 4, and is operable to list the content sources entered using field 502 and button 504. A button 508 is associated with box 506 and is operative to delete selected entries therefrom. Additionally, screen 500 includes a text entry field 510 that is suitably adapted for editing a content source selected from box 506. A button 512 is associated with field 510 and is operative to replace the existing entry in box 506 with the revised content source in field 510. It will be appreciated that screen 500 is merely exemplary of one suitable graphical user interface screen and that any other arrangement could alternately be used. Also, it will be appreciated that provisions for the entry and/or modification of any other suitable data, values and/or information could additionally, or alternately, be provided on screen 500.

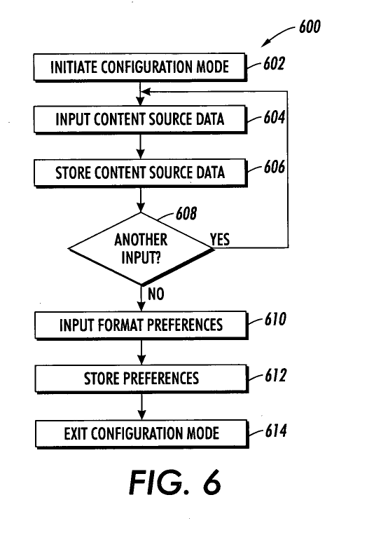

FIG. 6 illustrates one example of a method 600 of configuring a printing system for retrieving XML content from an XML content source and generating a printed representation of the retrieved content. Method 600 includes initiating a configuration mode, as indicated by box 602. Such an action can include, for example, microprocessor 138 retrieving an algorithm, routine or program from memory store 162 and executing the same. During execution, such an algorithm, routine or program could be graphically represented as shown in one or more of FIGS. 3-5, for example. Method 600 also includes receiving data, values and/or information related to a content source, as indicated by box 604. Such data, values and/or information could, for example, be entered by a user in text entry field 502 of FIG. 5. Method 600 also includes storing the content source data, values and/or information, as indicated by box 606. Such content source data, values and/or information can, for example, be stored by microprocessor 138 in memory store 142. Method 600 thereafter reaches a decision box 608 at which an inquiry is made as to whether additional content sources are to be input. If a YES determination is reached, method 600 returns to box 604 for entry of additional content source data, values and/or information. If a NO determination is reached, formatting, display and/or output preferences can be entered by the user, as indicated by box 610. Such a preference could, for example, include the entry of a check in check box 412 in FIG. 4 to indicate that only date and headline should be printed. Method 600 can then proceed to store any data, values and/or information related to the user-inputted preferences, as indicated by box 612. Such data, values and/or information could, for example, be stored by microprocessor 138 in memory store 146. Method 600 can then be exited, as indicated by box 614. It will be appreciated, however, that method 600 is merely one example of a suitable method for configuring a printing system, and that any other suitable method or arrangement could alternately be used.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A printing system capable of automatically outputting a printed representation of associated XML content data retrieved from an associated XML content source, said printing system comprising:
a sheet media source adapted to receive and dispense a quantity of associated sheets of media;
a marking unit operatively connected to said sheet media source, said marking unit adapted to receive the associated sheets of media from said sheet media source and generate associated marked sheets of media having a printed representation thereon;
a sheet media outlet in operative communication with said marking unit and receiving the associated marked sheets of media; and,
a control system in communication with at least said marking unit and capable of:
automatically retrieving associated XML content data from the associated XML content source;
automatically interpreting associated information data from the associated XML content data; and,
automatically generating associated marking data based at least in part on the associated information data and communicating the associated marking data to said marking unit.

2. A printing system according to claim 1, wherein said control system is capable of receiving an associated communication signal indicating that the associated XML content has been updated and automatically retrieving the associated XML content data from the associated XML content source in response to the associated communication signal.

3. A printing system according to claim 2, wherein said control system is capable of storing associated XML content source data having a relation to the associated XML content source and retrieving the associated XML content source data in response to the associated communication signal.

4. A printing system according to claim 1, wherein said control system is capable of storing associated formatting data and automatically generating the associated marking data based at least in part on the associated formatting data.

5. A printing system according to claim 1, wherein said control system is capable of storing the associated marking data from a first associated XML content source and combining associated marking data from a second associated XML content source with the associated marking data from the first associated XML content source.

6. A printing system capable of automatically outputting a printed representation of associated XML content data retrieved from an associated XML content source, said printing system comprising:
a sheet media source adapted to dispense associated sheets of media;
a marking unit operatively connected to said sheet media source, said marking unit adapted to receive the associated sheets of media from said sheet media source and generate associated marked sheets of media having a printed representation thereon;
a sheet media outlet in operative communication with said marking unit and receiving the associated marked sheets of media; and,
a control system in communication with at least said marking unit and including:
a communication interface operative to communicate with the associated XML content source;
a retriever operative to retrieve the associated XML content data from the associate XML content source through the communication interface;
an interpreter operative to parse the associated XML content data from said retriever into at least associated information data; and,
a generator operative to generate associated marking data based at least in part on the associated information data from said interpreter and communicate the associated marking data to said marking unit for generation of the associated marked sheets of media.

7. A printing system according to claim 6, wherein said control system includes a processing device capable of operating as at least one of said retriever, said interpreter or said generator.

8. A printing system according to claim 6, wherein the associated XML content data is formatted using an RSS standard and said interpreter is capable of parsing the associated information data from the associated XML content data using the RSS standard.

9. A printing system according to claim 6, wherein said control system includes a user interface and a memory, said user interface capable of receiving user-inputted data corresponding to the associated XML content source, and said memory capable of storing the associated XML content source data.

10. A printing system according to claim 6, wherein said control system includes a signal receiver operative to receive a communication signal indicating that the associated XML content data has been updated, and said retriever operative to retriever the associated XML content data in response to said communication signal.

11. A printing system according to claim 10, wherein said control system includes a memory capable of storing associated XML content source data having a relation to an address of the associated XML content source, and one of said signal receiver and said retriever being operative to access the associated XML content source data and determine the address of the associated XML content source therefrom.

12. A printing system according to claim 6, wherein said control system includes a formatter capable of formatting the associated information data, and said generator is operative to generate the associated marking data based on the associated formatted information data.

13. A printing system according to claim 12, wherein said control system includes a memory capable of storing associated user formatting data, and said formatter is operative to access the associated user formatting data and formatting the associated information data based at least in part thereon.

14. A printing system according to claim 6, wherein said control system includes a memory capable of storing associated user formatting data, and said generator is operative to access the associated user formatting data and generate the associated marking data based on at least the associated user formatting data and the associated information data.

15. A method of automatically generating a printed representation of XML content data from an XML content source, said method comprising:
a) providing a printing system capable of communicating with the XML content source;
b) configuring said printing system to retrieve XML content data from an XML content source;
c) retrieving XML content data from the XML content source using said printing system;
d) parsing information data from the XML content data using said printing system; and
e) generating a printed representation of the information data using said printing system.

16. A method according to claim 15, wherein said printing system includes an electrophotographic marking unit, and e) includes generating marking data corresponding to said information data and communicating said marking data to said marking unit.

17. A method according to claim 16, wherein said printing system includes a memory storing formatting data, and said method further comprises retrieving said formatting data and generating said marking data based on said information data and said formatting data.

18. A method according to claim 15 further comprising receiving a communication signal indicating that the XML content data has been updated, and retrieving the XML content data in response to the communication signal.

19. A method according to claim 15, wherein said printing system includes a user interface and a memory, and b) includes receiving user-inputted XML source data and storing the user-inputted XML source data in said memory.

20. A method according to claim 15, wherein c) includes retrieving first XML content data from a first XML content source and second XML content data from a second XML content source, d) includes parsing first information data from the first XML content data and second information data from the second XML content data, and e) includes generating said printed representation from said first and second information data.
